(19) United States
(12) Patent Application Publication
(10) Pub. No.: US 2015/0194281 A1
(43) Pub. Date: Jul. 9, 2015

(54) VIBRATION TRIGGER SWITCH

(71) Applicant: TERRY ELECTRONCS (S.Z.) CO., LTD., Shenzhen (CN)

(72) Inventors: Benrui Xu, Shenzhen (CN); John Gou, Shenzhen (CN)

(73) Assignee: TERRY ELECTRONCS (S.Z.) CO., LTD., Shenzhen (CN)

(21) Appl. No.: 14/146,759

(22) Filed: Jan. 3, 2014

(51) Int. Cl. H01H 35/14

(52) U.S. Cl. CPC H01H 35/142; H01H 35/144

(57) ABSTRACT

A vibration trigger switch includes a housing, a metal resilient element received in the housing, a conductive member received in the housing, and a pair of conductive pins. One end of the metal resilient element is fixed on one end of the housing, and another end is free. The conductive member is secured on another end of the housing, and defines a receiving space. The pair of conductive pins extend from the metal resilient element and the conductive member, respectively, and are exposed out of the housing. The free end of the metal resilient element partially extends into the receiving space of the conductive member. When the vibration trigger switch is vibrated, the free end of the metal resilient element vibrates to contact the conductive member to trigger the vibration trigger switch. The vibration trigger switch of the disclosure is low cost, and has good sensitivity and high reliability.

### BACKGROUND

1. Technical Field

The present disclosure generally relates to trigger switches, and especially to a vibration trigger switch.

2. Description of Related Art

Vibration trigger switches are widely employed in light triggering circuits of shoes, clothes and various toys. The light triggering circuits give out light when the shoes, clothes and toys are vibrated.

A vibration trigger switch generally includes a plastic housing, a spring received in the housing, and a conductive member. One end of the spring is secured on the housing and extends out of the housing, and another end of the spring is free. The conductive member is fixed with the housing by a hot melting process. One end of the conductive member is received inside spring coils of the spring, and another end of the conductive member extends out of the housing. When the vibration trigger switch is vibrated, the free end of the spring vibrates to contact the conductive member, so as to trigger the vibration trigger switch.

Due to small size of the conductive member, it is difficult to control an accurate position of the conductive member relative to the spring, and the conductive member deviates easily during the hot melting process. Once the conductive member deviates, the sensitivity of the vibration trigger switch is reduced greatly, and the vibration trigger switch is prone to be invalid in a production process, which results of repeat of adjusting test programs and low production efficiency. In addition, the spring is prone to keep contacting the conductive member under an external force all the time, due to a small inside diameter of the spring and weak seal of the vibration trigger switch. As a result, the vibration trigger switch keeps a triggering status all the time to become invalid.

Therefore, a need exists in the industry to overcome the described problems.

### SUMMARY

The purpose of the disclosure is to solve the problem that deviation of a conductive member of a vibration trigger switch causes the vibration trigger switch invalid.

In order to solve the problem, the disclosure offers technical proposal as follow.

A vibration trigger switch includes a housing, a metal resilient element, a conductive member, and a pair of conductive pins. The metal resilient element is received in the housing, one end of the metal resilient element is fixed on one end of the housing, and another end of the metal resilient element is free. The conductive member is received the housing and is secured on another end of the housing. The conductive member defines a receiving space. The pair of conductive pins extend from the metal resilient element and the conductive member, respectively, and are exposed out of the housing. The free end of the metal resilient element partially extends into the receiving space of the conductive member. When the vibration trigger switch is vibrated, the free end of the metal resilient element vibrates to contact the conductive member to trigger the vibration trigger switch.

Preferably, the metal resilient element is coaxial with the conductive member.

Preferably, the housing is in a shape of a cylinder.

Preferably, the housing includes a positioning post projecting from a center of one end of the housing, and one end of the metal resilient element sleeves the positioning post and is fixed with the positioning post.

Preferably, the metal resilient element is a spring.

Preferably, the conductive member is a spring, and an inside diameter of a spring coil of the conductive member is greater than an outside diameter of a spring coil of the metal resilient element. The spring coils of the conductive member resist an interior surface of the housing, and the free end of the metal resilient element partially extends inside the spring coils of the conductive member.

Preferably, the housing includes a hollow body and a pair of covers, the metal resilient element and the conductive member are received in the hollow body, and the pair of covers are fixed on two ends of the hollow body, respectively, to cover the hollow body.

It follows that the positioning structures of the metal resilient element and the conductive member of the vibration trigger switch are simple, and it is easy to control an accurate position of the conductive member relative to the metal resilient element, which avoids deviation of the conductive member during a production process, and prevents the vibration trigger switch invalid effectively. As a result, the production efficiency of the vibration trigger switch is improved, and the production cost of the vibration trigger switch is reduced correspondingly.

In addition, when the vibration trigger switch is vibrated, no matter the free end of the metal resilient element vibrates along anyone direction, the metal resilient element can contact the conductive member effectively to trigger the vibration trigger switch, which results of improvements of sensitivity and reliability of the vibration trigger switch.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic perspective view of a vibration trigger switch according to an exemplary embodiment of the disclosure.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

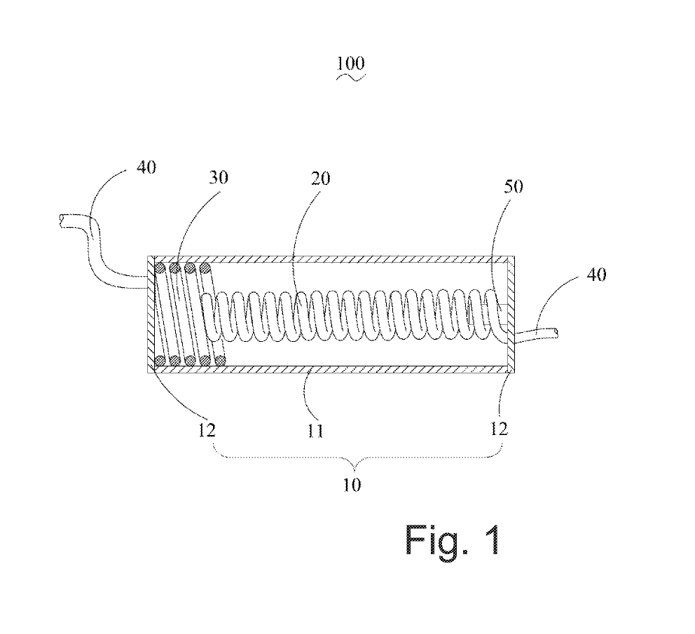

With reference to FIG. 1, a vibration trigger switch 100 of the disclosure includes a housing 10, a metal resilient element 20, a conductive member 30 and a pair of conductive pins 40.

In the embodiment, the housing 10 is made of plastic, and is insulated. The housing 10 is in a shape of a cylinder. Alternatively, the housing 10 may be in a shape of a cuboid.

The metal resilient element 20 and the conductive member 30 are received in the housing 10. One end of the metal resilient element 20 is fixed on one end of the housing 10, and another end of the metal resilient element 20 is free. The conductive member 30 is fixed on another end of the housing 10, and is opposite to the metal resilient element 20. The conductive member 30 defines a receiving space. The pair of conductive pins 40 extend from the metal resilient element 20 and the conductive member 30, respectively, and pass through the housing 10 to expose out of the housing 10. The free end of the metal resilient element 20 partially extends inside the receiving space of the conductive member 30.

In use, when the vibration trigger switch 100 is vibrated, the free end of the metal resilient element 20 vibrates to contact the conductive member 30. As a result, the pair of conductive pins 40 are electrically connected to trigger the vibration trigger switch 100.

In the embodiment, the metal resilient element 20 and the conductive member 30 are both springs. Each of the pair of conductive pins 40 extends from a corresponding spring, and is exposed out of the housing 10. An inside diameter of a spring coil of the conductive member 30 is greater than an outside diameter of a spring coil of the metal resilient element 20. The spring coil of the conductive member 30 resists an interior surface of the housing 10, which ensures the conductive member 30 is coaxial with the housing 10. The free end of the metal resilient element 20 partially extends inside the spring coil of the conductive member 30.

Alternatively, the conductive member 30 may be in other shapes made of conductive material, such as in a shape of a hollow cylinder, not limited in the shape of the spring.

In the embodiment, the housing 10, the metal resilient element 20 and the conductive member 30 are coaxial with each other. That is, an axis of the housing 10, an axis of the metal resilient element 20, and an axis of the conductive member 30 are co-linear, which ensures the free end of the metal resilient element 20 to contact the conductive member 30 to trigger the vibration trigger switch 100 effectively, no matter the free end of the metal resilient element 20 vibrates in anyone direction. As a result, the sensitivity and reliability of the vibration trigger switch 100 are improved.

In the embodiment, the housing 10 includes a positioning post 50 projecting from a center of one end of the housing 10. In assembly, one end of the metal resilient element 20 sleeves on the positioning post 50, and is fixed with the positioning post 50, which ensures the metal resilient element 20 coaxial with the conductive member 30. As a result, the free end of the metal resilient element 20 can contact the conductive member 30 effectively in anyone direction, which results improvements of sensitivity and reliability of the vibration trigger switch 100.

In detail, the housing 10 includes a hollow body 11 and a pair of covers 12. The metal resilient element 20 and the conductive member 30 are received in the hollow body 11. The covers 12 are fixed on the two ends of the hollow body 11, respectively, to cover the hollow body 11.

In the embodiment, the covers 12 are fixed with the hollow body 11 by a welding process, which seals the housing 10 effectively. Correspondingly, the positioning post 50 projects from a center of an inside surface of one of the covers 12.

It follows that the positioning structures of the metal resilient element 20 and the conductive member 30 of the vibration trigger switch 100 are simple, and it is easy to control an accurate position of the conductive member 30 relative to the metal resilient element 20, which avoids deviation of the conductive member 20 during a production process of the vibration trigger switch 100, and prevents the vibration trigger switch 100 invalid effectively. As a result, the production efficiency of the vibration trigger switch 100 is improved, and the production cost of the vibration trigger switch 100 is reduced correspondingly.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A vibration trigger switch comprising:
a housing;
a metal resilient element received in the housing, and wherein one end of the metal resilient element is fixed on one end of the housing, and another end of the metal resilient element is free;
a conductive member received the housing and secured on another end of the housing, and
wherein the conductive member defines a receiving space; and
a pair of conductive pins extending from the metal resilient element and the conductive member, respectively, and exposed out of the housing;
wherein the free end of the metal resilient element partially extends into the receiving space of the conductive member, and when the vibration trigger switch is vibrated, the free end of the metal resilient element vibrates to contact the conductive member to trigger the vibration trigger switch.

2. The vibration trigger switch of claim 1, wherein the metal resilient element is coaxial with the conductive member.

3. The vibration trigger switch of claim 1, wherein the housing is in a shape of a cylinder.

4. The vibration trigger switch of claim 1, wherein the housing comprises a positioning post projecting from a center of one end of the housing, and one end of the metal resilient element sleeves the positioning post and is fixed with the positioning post.

5. The vibration trigger switch of claim 4, wherein the metal resilient element is a spring.

6. The vibration trigger switch of claim 5, wherein the conductive member is a spring, and an inside diameter of a spring coil of the conductive member is greater than an outside diameter of a spring coil of the metal resilient element, the spring coils of the conductive member resist an interior surface of the housing, and the free end of the metal resilient element partially extends inside the spring coils of the conductive member.

7. The vibration trigger switch of claim 1, wherein the housing comprises a hollow body and a pair of covers, the metal resilient element and the conductive member are received in the hollow body, and the pair of covers are fixed on two ends of the hollow body, respectively, to cover the hollow body.
